(19) United States
(12) Patent Application Publication
(10) Pub. No.: US 2010/0005495 A1
(43) Pub. Date: Jan. 7, 2010

(54) Information and Entertainment System in an Aircraft

(75) Inventors: Mikael Stavaeus, Johanneshov (SE); Olaf Von Wieding, Neuenkirchen (DE); Wolfgang Süss, Hamburg (DE); Lars Rowold, Varel (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 12/223,728

(22) PCT Filed: Feb. 9, 2007
(86) PCT No.: PCT/EP2007/001130

§ 371 Date: Sep. 11, 2009

Related U.S. Application Data
(60) Provisional application No. 60/774,147, filed on Feb. 16, 2006.

(30) Foreign Application Priority Data
Feb. 16, 2006 (DE) 10 2006 007 284.7

(51) Int. Cl. H04N 7/18; G09G 3/30

(52) U.S. Cl. 725/76; 345/76

(57) ABSTRACT

An information system in an aircraft, whereby information system data relating to informing, instructing and entertaining passengers can be visually presented. The information system includes an aircraft window with at least one pane and a control unit. The at least one pane, is coated with a translucent display that is coupled to the control unit, which, for the purpose of presenting information, is equipped to supply electrical current in a targeted manner to the display.

### REFERENCE TO RELATED APPLICATIONS

This application claims the benefit of German Patent Application No. 10 2006 007 284.7 filed Feb. 16, 2006, and of U.S. Provisional Application No. 60/774,147 filed Feb. 16, 2006, the disclosures of which are hereby incorporated herein by reference.

### TECHNICAL FIELD

The present invention generally relates to the technical field of equipment installation in an aircraft. In particular, the invention relates to an information system in an aircraft, by means of which information system data relating to informing, instructing and entertaining passengers can be visually presented. Furthermore, the invention relates to an aircraft equipped with an information system according to the invention.

### BACKGROUND TO THE INVENTION

In older types of large-capacity passenger aircraft, in particular in economy class, it is common for only a few monitors or flat-panel monitors to be arranged, distributed in the cabin, for entertaining, instructing and informing passengers. However, these monitors are often arranged such that only a few passengers have an unrestricted view of the monitors.

Furthermore, in particular in newer types of large-capacity passenger aircraft, in particular in first class and in business class, it is common for the backrests of the passenger seats to comprise small flat-panel monitors, on which the person seated behind can call up information or view entertainment programs. However, these flat-panel monitors are associated with considerable weight, which is of course always undesirable in the field of aircraft and space technology.

### SUMMARY OF THE INVENTION

Based on the disadvantages associated with known information- and entertainment systems, as described above, there may be a need for an information system that is light in weight and that can be seen from any seat.

According to a first aspect of the present invention, this need may be met by an information system that is specially designed to be used in an aircraft. In this arrangement the information system according to the invention comprises an aircraft window with at least one windowpane. Apart from this the information system comprises a control unit that is adapted to process, for the information system, the data intended for visual presentation and to provide such data in processed form to the information system. In order to be able to visually or graphically present information relating to information, instruction or entertainment, the information system further comprises a translucent display with which the at least one pane of the aircraft window is coated. This translucent display is coupled to the above-mentioned control unit, which is correspondingly adapted to supply electrical current in a targeted manner to the translucent display, for the purpose of presenting the above-mentioned information.

According to another aspect, the need on which the invention is based is also met with an aircraft that comprises the information system according to the invention.

Since, as a rule, an aircraft window is associated with each seat row in a large-capacity passenger aircraft, the information system can be viewed almost equally well from any seat. However, since it is of course not desirable that, because the display of the information system is arranged on the windowpanes, the view to the outside is restricted, the display is designed so as to be translucent so that at least a partially unimpeded view to the outside continues to be possible even while information is presented on the display.

Such a translucent display can, for example, be made from a multitude of light emitting diodes. In particular the translucent display of the information system can comprise a multitude of organic light emitting diodes (OLEDs), which can, for example, be applied directly in the form of a coating to the at least one pane.

As an alternative to the above, the organic light emitting diodes can also be applied to a transparent substrate as a carrier material, for example a polymer film, glass or quartz, which carrier material is then used to coat the pane, in particular glued onto or laminated onto the pane of the aircraft window.

In the case of organic light emitting diodes (hereinafter referred to as OLEDs), these can be light emitting diodes made of organic semiconducting polymers or small molecules that can be produced far more economically than inorganic LEDs. By arranging a multitude of small OLEDs it is, for example, possible to create a graphic display as proposed for use in the context of the present invention. As an alternative, the OLEDs applied to the pane of the aircraft window can also be used for illumination purposes, for example to generate specific illumination scenarios. Since a display constructed in this way with the use of OLEDs, in contrast to conventional liquid-crystal display monitors, does not need background illumination, the display can be designed so as to be translucent, which in the context of the application according to the invention is necessary so as not to impede the unrestricted view through the aircraft window. Apart from this, the fact that no background illumination is needed has a positive effect on the weight of the display so that considerable weight can be saved when compared to conventional liquid-crystal display monitors.

A display produced with the use of OLEDs further features a large angle of view region of up to 170° and a fast circuit speed, so that a display produced in this way is suitable to reproduce moving images. Furthermore, if they are made as coated films, OLED displays are thin and flexible so that they can also be used on curved (window) surfaces.

According to a further aspect of the invention, the information system comprises a server computer or central computer that is equipped with a storage unit in which a multitude of different applications or entertainment media can be stored, which can be presented or played on the display of the information system. To this effect, by accessing the applications stored in the storage unit, the server computer provides image data to the control unit, which in turn converts this image data to corresponding control signals.

In order to convert the image data to control signals, the control unit can, for example, comprise at least one display controller with a microprocessor, which recalculates the image data that has been provided by the server computer to form a matrix model that is used as a basis for supplying electrical current to the display. In this arrangement each display controller has an ID of its own so as to be able to be identified and addressed by the server computer so that the display controllers can by fed with (image-) data by the server computer. In this arrangement, recalculating the image data to form a matrix model takes place by means of the microprocessor, because the individual organic diodes of the display are arranged in a corresponding manner in a line-column matrix so that a specific line number or column number can be allocated to each individual diode, which diode emits a coloured light when a voltage is applied.

Since it is not always desirable to display the same information or the same entertainment program on each display, a particular group of aircraft windows can have a display controller of their own allocated to them. In this case, apart from its functionality to control the display, the display controller can also have a further functionality that makes it possible to address the server computer in order to select a particular application by means of the display controller, which application is to be displayed on a group of aircraft windows or on the displays fitted to said aircraft windows.

Since, in particular in the presentation of entertainment programs such as feature films, moving images have to be visually presented, each display controller is coupled to the server computer by way of a data bus that is equipped to implement or ensure real-time data transmission. Such a data bus can, for example, be a network system, for example the Airbus CIDS cabin management system, which can be installed as a central control unit in an aircraft. To provide multimedia contents, the system can be designed as a streaming solution. Normally this cabin management system controls important cabin functions and handles the display of status information for passengers and the crew, and can thus without major modifications be used to transmit image data.

For the purpose of inputting information the OLED display can comprise a touch screen functionality. In this way a user can make a selection of objects by touching the display.

The server computer required for the information system can be implemented as part of an existing computer in the aircraft, or as a separate computer (high-performance hardware). In this arrangement the central computer is integrated into or connected to the network of the aircraft, such as for example the CIDS in order to make it possible to use flight data in various applications. The display controller can be designed as a streaming client in order to process the information provided by the server.

With the information system according to the invention various types of information can be presented, such as, for example, flight data and travel data, entertainment information, geographic information or illumination scenarios in the passenger cabin. For example, by accessing a GPS application, information relating to the distance and direction of geographic situations can be presented on the window displays so that flight passengers are always graphically informed about their actual position. Generally speaking, the range of possible applications that can be presented on the displays is vast, so that below only some options are mentioned by way of examples.

For example, the following can be shown on the displays: advertising information relating to an aircraft operator or airline; general flight information such as flight altitude, speed and distance; seat numbers; safety information; information relating to emergency exits; animated entertainment such as feature films or children's films; information relating to onward flight connections, depending on the particular passenger seated beside the information system concerned; or various illumination scenarios. Furthermore, the information system according to the invention can be used to reduce the incoming light in that the individual organic light emitting diodes are made to produce a dark colour.

### BRIEF DESCRIPTION OF THE DRAWINGS

Below, the present invention is explained by way of an example with reference to the enclosed drawings. It should be emphasised that the embodiments of the invention as shown in the figures explain the invention merely by way of an example and should in particular not be interpreted in any way as limiting the scope of protection. The following are shown:

FIG. 1 a system overview of the information system according to the invention; and

FIG. 2 the basic design of an OLED light emitting diode.

### DESCRIPTION OF AN EXEMPLARY EMBODIMENT OF THE INVENTION

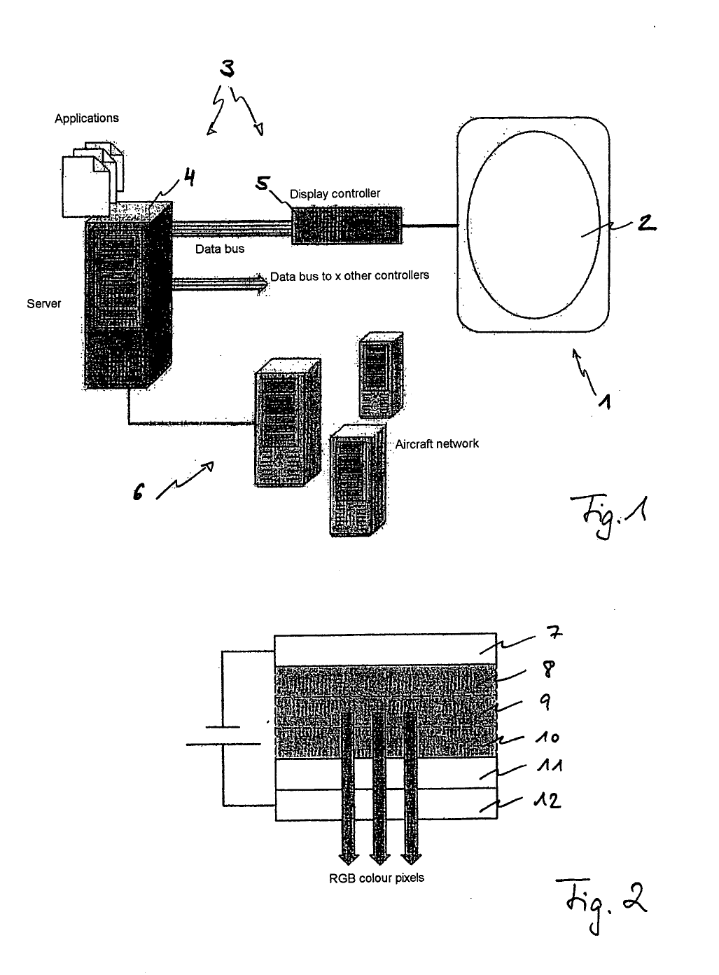

FIG. 1 shows a system overview of the information system according to the invention. As shown in FIG. 1, the information system according to the invention comprises at least one aircraft window 1 to which at least one windowpane 2 has been fitted. Furthermore, the information system also comprises a control unit 3, which can, for example, comprise a server computer 4 with a multitude of display controllers 5. In order to be able to visually display certain information or entertainment media on the windowpane, the pane 2 of the aircraft window 1 is coated with a translucent display. This coating can, for example, be implemented by direct coating of the pane 2 with a multitude of organic light emitting diodes. As an alternative, the coating can be implemented by means of a film on which OLEDs are arranged in columns and rows.

As further shown in FIG. 1, the translucent display of the aircraft window 1 is coupled to the control unit 3 in order to be caused, by the control unit, to display the desired information, which can, for example, be stored in a storage unit on the server computer. In order to be able to present the image information, which is stored on the server computer, by means of the aircraft window that has been coated with OLEDs, a display controller 5 is connected between the display of the aircraft window 1 and the server computer 4, which display controller 5 recalculates the image data provided by the server computer 4 to create a matrix model, so that depending on this matrix data electrical current can be applied to the OLEDs that are arranged on the windowpane 2 in columns and rows.

As shown in FIG. 1, several display controllers 5 can be connected to the server computer 4 in order to be able to separately address the displays of individual aircraft windows 1, and in order to be able to provide said displays with different image data. In this arrangement the individual display controllers can be arranged directly near the aircraft windows 1, for example on the rear of the window lining or on the rear of the cabin lining. In this way various types of information data or entertainment data can be presented on the displays of different aircraft windows 2.

In this arrangement the individual display controllers 5 are thus coupled to the server computer 4 by way of a data bus which is able to ensure real-time data transmission so that presentation of moving images is possible without any jerking or delay.

As shown in FIG. 1, the server computer 4 is incorporated in the network system 6 of the aircraft, which network system 6 can, for example, be the Airbus CIDS cabin management system, which is installed as a central control unit in Airbus aircraft.

Finally, with reference to FIG. 2, the function of a display coated with OLEDs is described. For example an organic dye provides the key to the function of OLEDs. This dye has various states of excitation. If an electron coincides with a hole in the dye, an excited state is created, from which a photon (light particle) can be emitted. The dye can also be excited by light, which can, for example, result in fluorescence.

The excited states are generated in a thin film 8 of the dye. Electrical current flows through this film 8 in the following manner: excited electrons on one side are fed to holes in the other side of the anode 11 by way of a metal cathode 7. The electrons and holes move in the dye 8, meet, and form excited states. In this process, typically, a voltage of approximately 5 to 10 volt is present between the metallic cathode 7 and the transparent anode. When the electrons “fall” into the holes (recombination), the desired light is emitted through the transparent substrate 12, which can, for example, be the windowpane 2 of the aircraft window. The colour of this light depends on the energy released during this process.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments can also be used in combination with other characteristics or steps of other exemplary embodiments described above. Reference characters in the claims are not to be interpreted as limitations.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

### LIST OF REFERENCE CHARACTERS

1 Aircraft window
2 Windowpane
3 Control unit
4 Server computer
5 Display controller
6 Network system
7 Cathode
8 Dye film
9 Exitone
10 Hole injection
11 Anode
12 Transparent substrate pane

1. An information system in an aircraft, comprising:
an aircraft window with at least one pane; and
a control unit;
wherein the at least one pane is coated with a translucent display that is coupled to the control unit which, for the purpose of presenting information, supplies electrical current in a targeted manner to the display.

2. The information system of claim 1,
wherein the translucent display comprises a plurality of light emitting diodes.

3. The information system of claim 2,
wherein the translucent display comprises a plurality of organic light emitting diodes.

4. The information system of claim 3,
wherein the at least one pane is directly coated with the organic light emitting diodes.

5. The information system of claim 3,
wherein a film is glued onto the at least one pane, which film in turn is coated with the organic light emitting diodes.

6. The information system of claim 1, further comprising:
a server computer with a storage unit,
wherein the server computer, by accessing applications stored in the storage unit, provides image data to the control unit.

7. The information system of claim 1,
wherein the control unit comprises at least one display controller with a microprocessor, which recalculates the image data that has been provided by the server computer to form a matrix model that is used as a basis for supplying electrical current to the display.

8. The information system of claim 1,
wherein a group of aircraft windows is allocated a display controller of its own.

9. The information system of claim 7,
wherein each one of the display controllers is coupled to the server computer by way of a data bus that is adapted to implement real-time data transmission.

10. The information system of claim 9,
wherein each display controller is adapted to request and receive, for the group of aircraft windows, individual application data from the server computer.

11. An aircraft comprising an information system, the information system comprising:
an aircraft window with at least one pane; and
a control unit;
wherein the at least one pane is coated with a translucent display that is coupled to the control unit which, for the purpose of presenting information, supplies electrical current in a targeted manner to the display.
